(19) United States
(12) Patent Application Publication
(10) Pub. No.: US 2007/0246492 A1
(43) Pub. Date: Oct. 25, 2007

(54) Nursing purse and method for converting a purse to a nursing pillow

(76) Inventor: Amy N. Carpentieri, Berkley Springs, WV (US)

Correspondence Address: LERNER GREENBERG STEMER LLP, P O BOX 2480, HOLLYWOOD, FL, 33022-2480, US

(21) Appl. No.: 11/788,991

(22) Filed: Apr. 23, 2007

Related U.S. Application Data
(60) Provisional application No. 60/793,862, filed on Apr. 21, 2006.

(51) Int. Cl. A61G 1/00; A61G 5/00

(52) U.S. Cl. 224/158

(57) ABSTRACT

A nursing purse includes a crescent-shaped body having an outer cover shaped as a purse, an inner liner defining a space within the body for holding items, and a filling disposed between the outer cover and the an inner liner for permitting the body to act as a pillow for a nursing baby. A closure is connected to the outer cover and the inner liner for maintaining the items in the space. Straps are connected to opposite locations on the crescent-shaped body and configured to be tied together and slung over the shoulder as a purse or wrapped around the waist of a mother as a pillow for nursing a child. A method for converting a purse to a nursing pillow is also provided.

### CROSS-REFERENCE TO RELATED APPLICATIONS

This application claims the priority, under 35 U.S.C. §119, of U.S. Provisional Patent Application No. 60/793,862, filed Apr. 21, 2006; the prior application is herewith incorporated by reference in its entirety.

### BACKGROUND OF THE INVENTION

1. Field of the Invention

The invention relates to a nursing purse to be used as a purse, as a pillow during nursing and as a diaper bag for baby products. The invention also relates to a method for converting a purse to a nursing pillow.

2. Description of the Related Art

U.S. Pat. No. 6,484,337 B1 shows a nursing pillow 12 having a closure extending around the waist of the mother. Although fillings are provided in a cavity section 18 as discussed in column 3, lines 9-21 thereof, there is no disclosure of adding or removing items for use as a bag. U.S. Pat. No. 6,412,128 B1 similarly shows a nursing pillow 10 having a core 30 as described in column 3, last paragraph. There is also no discussion therein of adding or removing of items from the pillow. Finally, U.S. Pat. No. 5,154,649 discloses a nursing pillow 2 with air chambers 6, 8, which are not used for holding items.

U.S. Pat. No. 6,493,891 B1 shows a tote bag 12 carrying a pillow 40. Similarly, U.S. Pat. No. 2,451,142 discloses a bag, which opens to form a pillow and a blanket.

Crescent-shaped pillows, cushions and handbags are shown in U.S. Pat. No. 3,911,512, U.S. Pat. No. Des. 418,975, U.S. Pat. No. Des. 369,675, U.S. Pat. No. Des. 310,296, U.S. Pat. No. Des. 299,384, U.S. Pat. No. Des. 294,195, U.S. Pat. No. Des. 230,804 and U.S. Design Pat. No. D468,904 S.

Handbag inserts are shown in U.S. Patent Application Publication No. US 2005/0000992 A1, U.S. Patent Application Publication US 2004/0187987 A1, U.S. Pat. No. 2,618,790, U.S. Pat. No. 2,661,785 and U.S. Patent Application Publication US 2005/0155152 A1. The handbag 10 disclosed in U.S. Pat. No. 2,661,785 has insulation 26.

U.S. Pat. No. 1,677,743 discloses a bag having outer surfaces A, A′ and inner surfaces B, B′, which are formed of padding. The bag is turned inside out to form a cushion.

U.S. Pat. No. 3,938,569 discloses a handbag 10 with an article carrying section 12. Pads 32, 34 provide cushioning for the outside of the bag, as shown in FIG. 3. Column 2, lines 24-29 thereof state that the pads permit the handbag to be used as a cushion.

However, none of the prior art, whether taken alone or in any combination, show or suggest a combination of a purse, a diaper bag for holding baby items and cushioning permitting use as a nursing pillow.

### SUMMARY OF THE INVENTION

It is accordingly an object of the invention to provide a nursing purse and a method for converting a purse to a nursing pillow, which overcome the hereinafore-mentioned disadvantages of the heretofore-known devices and methods of this general type and which provide all of the functions which the mother of an infant requires in one device, that is a purse, a diaper bag for holding baby items and cushioning for use as a nursing pillow.

With the foregoing and other objects in view there is provided, in accordance with the invention, a nursing purse. The nursing purse comprises a crescent-shaped body having an outer cover shaped as a purse, an inner liner defining a space within the body for holding items, and a filling disposed between the outer cover and the an inner liner for permitting the body to act as a pillow for a nursing baby. A closure is connected to the outer cover and the inner liner for maintaining the items in the space. Straps are connected to opposite locations on the crescent-shaped body and configured to be tied together and slung over the shoulder as a purse or wrapped around the waist of a mother as a pillow for nursing a child. Thus one device simultaneously acts as a purse, a nursing pillow and a diaper bag.

In accordance with another feature of the invention, the closure is a zipper. This is a convenient closure, although other closures generally used for purses or diaper bags may be used as well.

In accordance with a further feature of the invention, the outer cover is formed of cotton and the inner liner is formed of cotton or a water-proof material.

In accordance with an added feature of the invention, the filling is formed of a cotton and polyester material. Such a filling provides the required pillow-like softness and yet is firm enough to support the baby.

With the objects of the invention in view, there is also provided a method for converting a purse to a nursing pillow. The method comprises providing a crescent-shaped body having an outer cover shaped as a purse, an inner liner defining a space within the body for holding items, a filling disposed between the outer cover and the inner liner for permitting the body to act as a pillow for a nursing baby, straps connected to opposite locations on the crescent-shaped body, and a closure connected to the outer cover and the an inner liner for maintaining the items in the space. The straps are alternately tied together and slung over the shoulder as a purse, or wrapped around the waist of a mother as a pillow for nursing a child. The method accordingly converts the device between a purse or diaper bag and a nursing pillow.

The nursing purse according to the invention is specifically constructed to create comfort and ease for a breastfeeding mother, bottle-feeding parent, or anyone holding a baby, by providing support for the arm that is holding the baby. The purse becomes a perfectly fitted pillow for the arm to rest on while the baby nurses and eats or sleeps. The nursing purse is crescent-shaped so as to wedge around a person's waist and under their arm to support the arm that is holding the baby. The nursing purse solves the problem presented by nursing, feeding or holding a baby in public or outside the comfort of one's home since it is portable and functions as a purse and baby feeding, nursing, holding support device as well.

The nursing purse is able to be used quickly and easily in order to prevent a baby form becoming upset when hungry, which can happen rapidly. For use as a purse, the straps are tied to the desired length, then approximately 5-8 diapers are added and spread evenly throughout the purse for extra cushioning for the baby. Finally, wipes and other necessary items are added.

For use as an armrest during breastfeeding or bottle feeding of a baby, the straps are untied, the nursing purse is turned on its side just above the mother's hip and the straps are retied securely above the mother's waist. The nursing purse may also be placed above the mother's hip while leaving the straps tied in its original position, although it is recommended that the straps be tied around the mother's waist for the full support and comfort for a newborn.

For use as an Armrest with a sleeping baby, the nursing purse is placed under an adult's arm. If the baby is resting on the adult's shoulder, the purse is wrapped around the adult's stomach. When cradling the baby sideways, the nursing purse is placed above the adult's hip.

The novelty of the nursing purse is that no other device exists that acts as a device for nursing, feeding, holding and supporting a baby, is portable, comfortable, ergonomical, able to be used “on the go” and functions as a purse which can carry diapers, baby wipes, wallet, keys, lipstick, and other general contents of a purse or diaper bag.

Other features which are considered as characteristic for the invention are set forth in the appended claims.

Although the invention is illustrated and described herein as embodied in a nursing purse and a method for converting a purse to a nursing pillow, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of the nursing purse according to the invention being worn by a woman as a purse;

FIG. 2 is a side-elevational view of the nursing purse being used as a nursing pillow by a mother in a seated position;

FIG. 3 is a top-plan view of the nursing purse with the zipper partially opened;

FIG. 4 is a sectional view of the nursing purse; and

FIG. 5 is a side-elevational view of the nursing purse in an outline form.

### DESCRIPTION OF THE PREFERRED EMBODIMENTS

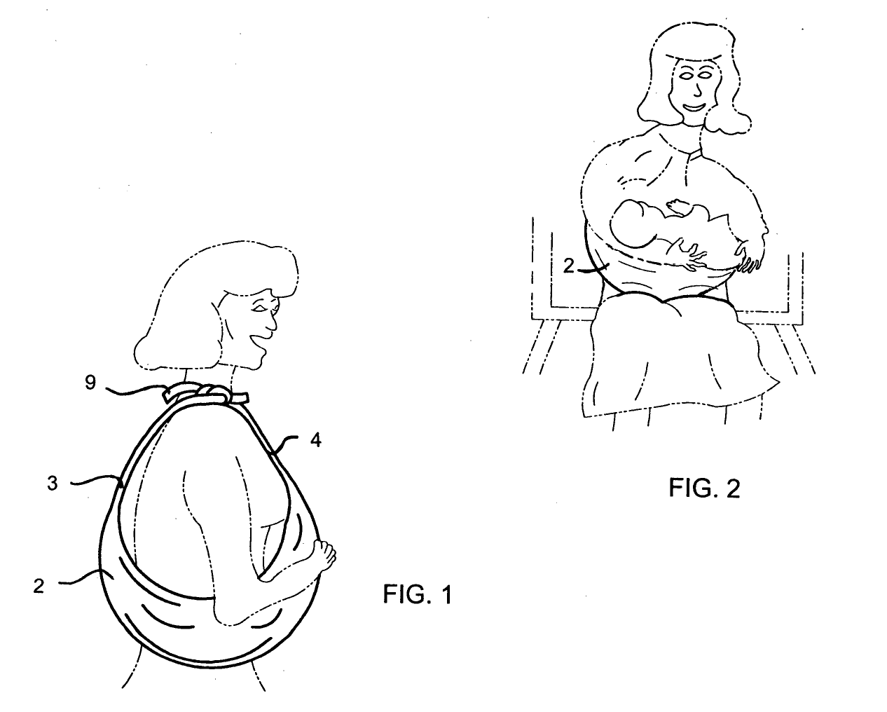

Referring now to the figures of the drawings in detail and first, particularly, to FIG. 1 thereof, there is seen a nursing purse according to the invention having a crescent-shaped body 2 and straps 3, 4 tied together at a knot 9 and slung over the shoulder of a mother wearing the device as a purse or handbag. Of course, a buckle, hook and loop fasteners, buttons, snaps or any other suitable closure may be used as well and the straps may be adjustable in length.

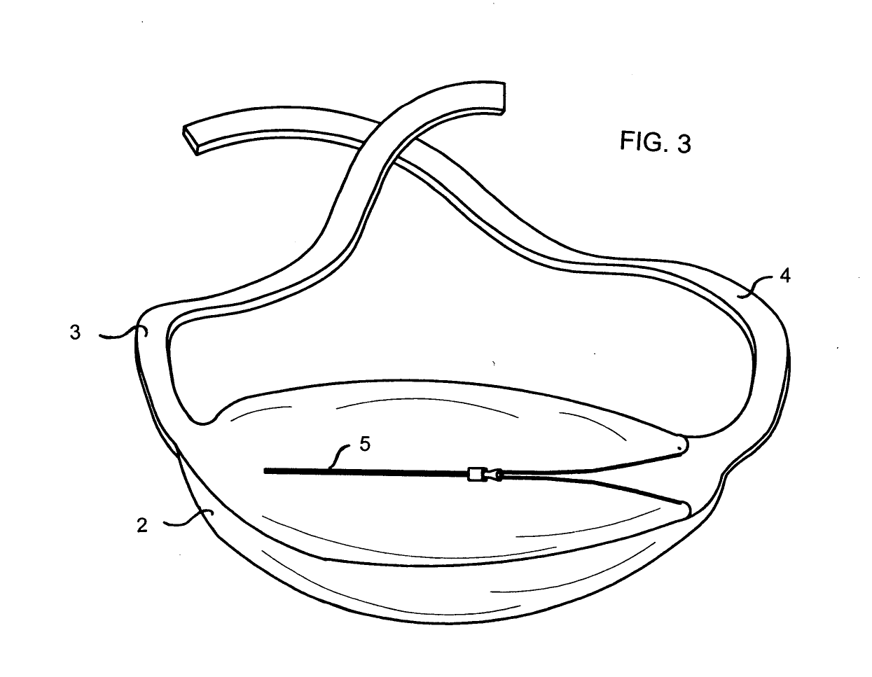

FIG. 2 shows that the straps 3, 4 can wrap around the waist of the mother to secure it in place, if necessary, when the nursing purse is being used as a nursing pillow. In this position, the crescent shape of the body 2 extends from the lap of the mother, under her arm and partially toward her side. The baby rests on the body 2 of the nursing purse as a pillow is such a way that the baby's head is in the nursing position and yet the baby rests comfortably.

As is seen in FIG. 3, a zipper 5 closing the top of the body 2 of the nursing purse is partially opened, whereas it is completely closed in FIGS. 1 and 2. The zipper encloses a space inside for necessary items, such as several diapers, wipes, a wallet, keys, small baby toys, a cell phone and other general contents of a purse or diaper bag, so that they are easily portable.

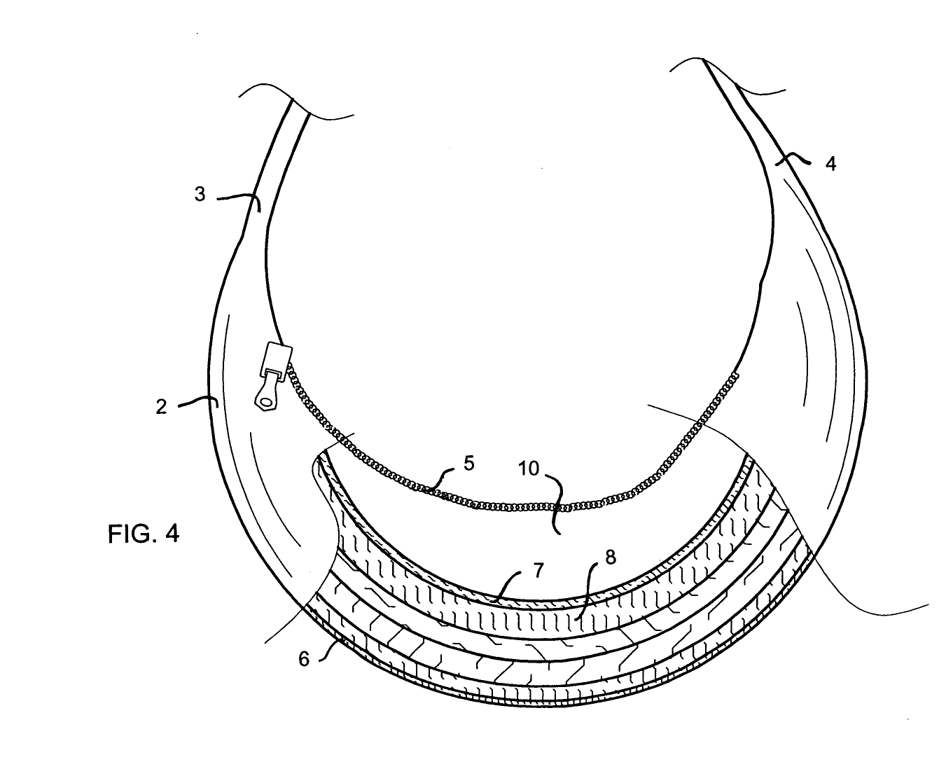

FIG. 4 shows that the body 2 has an outer covering 6 shaped as a purse, an inner liner 7 and a filling 8 disposed between the inner liner 7 and the outer covering 6 so as give the body 2 of the nursing purse a soft pillow-like cushioning for the baby. The quality of the fabric and padding inside and outside of the nursing purse should be safe and all natural.

The outer covering 6 may be formed of any soft material such as woven or nonwoven fabrics, vinyl or leather, etc., although 100% cotton is preferred. The inner liner 7 may be formed of 100% cotton as well, although a water-proof material such as vinyl may also be used. The filling 8 may be formed of 80% cotton and 20% polyester, although any cushioning may be used.

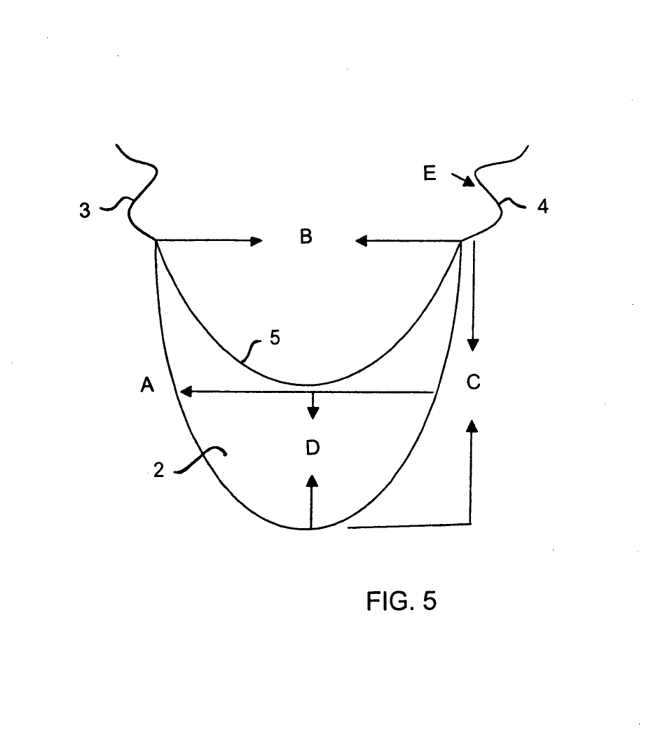

As is shown in a highly diagrammatic manner in FIG. 5, the crescent-shaped body 2 has a width A at its widest location of approximately 18.5″ (inches), a width B where the straps 3, 4 are attached of approximately 13.5″, a height C of approximately 12, and a smallest depth D from the zipper 5 to the bottom of the body 2 of approximately 9.5″. The straps 3, 4 may have a length E of be approximately 39″.

I claim:

1. A nursing purse, comprising:
a crescent-shaped body having an outer cover shaped as a purse, an inner liner defining a space within said body for holding items, and a filling disposed between said outer cover and said an inner liner for permitting said body to act as a pillow for a nursing baby;
a closure connected to said outer cover and said inner liner for maintaining the items in said space; and
straps connected to opposite locations on said crescent-shaped body and configured to be tied together and slung over the shoulder as a purse or wrapped around the waist of a mother as a pillow for nursing a child.

2. The nursing purse according to claim 1, wherein said closure is a zipper.

3. The nursing purse according to claim 1, wherein said outer cover is formed of cotton.

4. The nursing purse according to claim 1, wherein said inner liner is formed of cotton.

5. The nursing purse according to claim 1, wherein said inner liner is formed of a water-proof material.

6. The nursing purse according to claim 1, wherein said filling is formed of a cotton and polyester material.

7. A method for converting a purse to a nursing pillow, the method comprising the following steps:
providing a crescent-shaped body having an outer cover shaped as a purse, an inner liner defining a space within the body for holding items, a filling disposed between the outer cover and the inner liner for permitting the body to act as a pillow for a nursing baby, straps connected to opposite locations on the crescent-shaped body, and a closure connected to the outer cover and the an inner liner for maintaining the items in the space; and
alternately tying the straps together and slinging the straps over the shoulder as a purse, or wrapping the straps around the waist of a mother as a pillow for nursing a child.
